(19) United States
(12) Patent Application Publication
(10) Pub. No.: US 2018/0088791 A1
(43) Pub. Date: Mar. 29, 2018

(54) METHOD AND APPARATUS FOR PRODUCING VIRTUAL REALITY CONTENT FOR AT LEAST ONE SEQUENCE

(71) Applicant: VROTEIN INC., Seongnam-si (KR)

(72) Inventors: Chan Ki KIM, Gwangju-si (KR); Kwang Soo LEE, Seongnam-si (KR)

(21) Appl. No.: 15/354,278

(22) Filed: Nov. 17, 2016

(30) Foreign Application Priority Data
Sep. 23, 2016 (KR) 10-2016-0122271

(51) Int. Cl. G06F 3/0484; G06F 3/0486; G06T 13/40; G06F 3/0482

(52) U.S. Cl. CPC G06F 3/04847; G06F 3/0486; G06T 2200/24; G06T 13/40; G06F 3/0482; G06F 3/04845

(57) ABSTRACT

Provided is a method for producing a virtual reality content for at least one sequence. The method may include: displaying at least one action setting zone for setting an action of a virtual reality character, a list zone for displaying a setting value to be input into the at least one action setting zone, and a preview zone for displaying an action of the virtual reality character; receiving a user input, dragging and dropping at least one of setting values, which is a setting value for a first action of the virtual reality character, displayed on the list zone to a first action setting zone; receiving a user input and setting a setting value for a second action of the virtual reality character into a second action setting zone; and displaying, on the preview zone, at least one scene showing actions of the virtual reality character.

### CROSS-REFERENCE TO RELATED APPLICATION

This application claims the benefit under 35 USC 119(a) of Korean Patent Application No. 10-2016-0122271 filed on Sep. 23, 2016, in the Korean Intellectual Property Office, the entire disclosures of which are incorporated herein by reference for all purposes.

### TECHNICAL FIELD

The present disclosure relates to a method and an apparatus for producing a virtual reality content for at least one sequence and more particularly, to a method and an apparatus for providing a user with a convenient and intuitive user interface for producing a virtual reality content.

### BACKGROUND

With the development of computer technology, virtual reality (VR) technology has been rapidly developed and actually applied to various fields. In recent years, the application fields of the VR technology have been widened gradually to education and shopping fields beyond game and entertainment fields. Therefore, demands for VR contents have been increased gradually.

In order to produce and control contents of such a complicated virtual world, great skill at a VR content producing tool is needed. Accordingly, a method of reducing a time required for producing a VR content by providing multiple standard templates has been disclosed. However, in a conventional VR content producing tool, a user interface is not intuitive. Thus, it is very difficult for a user to produce a content before being skilled at the producing tool. Further, the conventional VR content producing tool is very limited in scope of application. Thus, it is difficult to express advanced actions, such as moving all s or depicting all objects in a content as interacting with a user.

### SUMMARY

In view of the foregoing, a method and an apparatus for producing a virtual reality content according to an exemplary embodiment of the present disclosure discloses a user-intuitive user interface including an action setting zone, a list zone, and a preview zone.

Further, multiple action setting zones corresponding to multiple scenes are provided, and, thus, it is possible to produce a virtual reality content for a sequence formed by combining multiple scenes of actions of a virtual reality character according to setting values of the action setting zones on one screen.

However, problems to be solved by the present disclosure are not limited to the above-described problems. Although not described herein, other problems to be solved by the present disclosure can be clearly understood by those skilled in the art from the following descriptions.

Provided is a method for producing a virtual reality content for at least one sequence performed by a virtual reality content producing apparatus. The method may include: displaying at least one action setting zone for setting an action of a virtual reality character to be displayed in virtual reality, a list zone for displaying a setting value to be input into the at least one action setting zone, and a preview zone for displaying an action of the virtual reality character according to the setting value input into the action setting zone; receiving a user input, dragging and dropping at least one of setting values, which is a setting value for a first action of the virtual reality character, displayed on the list zone to a first action setting zone; receiving a user input and setting a setting value for a second action of the virtual reality character into a second action setting zone; and displaying, on the preview zone, at least one scene showing actions of the virtual reality character according to setting values of the first action setting zone and the second action setting zone, wherein the first and second action setting zones are displayed as being arranged in parallel according to the order of being produced and are able to be randomly changed in order by a user input.

Further, the at least one action setting zone includes setting values for a sequence including multiple scenes, and the displaying on the preview zone includes: continuously playing, on the preview zone, the respective scenes of actions of the virtual reality character according to the setting values.

Besides, another method and another system for implementing the present disclosure and a computer-readable storage medium that stores a computer program for performing the method may be further provided.

The present disclosure provides a user-intuitive user interface including at least one action setting zone, a list zone, and a preview zone according to an exemplary embodiment. Thus, it is possible to more easily produce a virtual reality content including a scene in which a virtual reality character performs an action. Further, a user can intuitively change a setting value in one action setting zone. Thus, it is possible to easily produce a scene in which a virtual reality character performs an action.

Furthermore, a method for producing a virtual reality content according to an exemplary embodiment enables a directing sequence to be user-intuitively displayed and also makes it easy for a user to move all objects in a content to a desired position at a desired time.

Moreover, in the method for producing a virtual reality content according to an exemplary embodiment, a setting value is modified to modify an action to be output according to a user input value. Thus, it is possible to easily produce a virtual reality content moved in real time in response to the user's gaze (angle and direction of the user's face), voice, and a touch input through a hardware button of a VR apparatus.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a conceptual image provided to explain a method for producing a virtual reality content for at least one sequence in accordance with an exemplary embodiment of the present disclosure.

FIG. 2 is a flowchart illustrating the method for producing a virtual reality content for at least one sequence in accordance with an exemplary embodiment of the present disclosure.

FIG. 3A through FIG. 3D are images illustrating an example of the method for producing a virtual reality content for at least one sequence in accordance with an exemplary embodiment of the present disclosure.

FIG. 4 through FIG. 28 are images illustrating an example of an action setting zone in the method for producing a virtual reality content for at least one sequence in accordance with an exemplary embodiment of the present disclosure.

FIG. 29 through FIG. 31 are images provided to explain an example of a method for creating a sequence in the method for producing a virtual reality content for at least one sequence in accordance with an exemplary embodiment of the present disclosure.

FIG. 32 is a block diagram illustrating an apparatus for producing a virtual reality content for at least one sequence in accordance with an exemplary embodiment of the present disclosure.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “unit” includes a unit implemented by hardware, a unit implemented by software, and a unit implemented by both of them. One unit may be implemented by two or more pieces of hardware, and two or more units may be implemented by one piece of hardware. However, the “unit” is not limited to the software or the hardware, and the “unit” may be stored in an addressable storage medium or may be configured to implement one or more processors. Accordingly, the “unit” may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and functions provided in the “units” can be combined with each other or can be divided up into additional components and “units”. Further, the components and the “units” may be configured to implement one or more CPUs in a device or a secure multimedia card.

A “user device” to be described below may be implemented with computers or portable devices which can access a server or another device through a network. Herein, the computers may include, for example, a notebook, a desktop, and a laptop equipped with a WEB browser. For example, the portable devices are wireless communication devices that ensure portability and mobility and may include all kinds of handheld-based wireless communication devices such as IMT (International Mobile Telecommunication)-2000, CDMA (Code Division Multiple Access)-2000, W-CDMA (W-Code Division Multiple Access), Wibro (Wireless Broadband Internet) and LTE (Long Term Evolution) communication-based devices, a smart phone, a tablet PC, and the like. Further, the “network” may be implemented as wired networks such as a Local Area Network (LAN), a Wide Area Network (WAN) or a Value Added Network (VAN) or all kinds of wireless networks such as a mobile radio communication network or a satellite communication network.

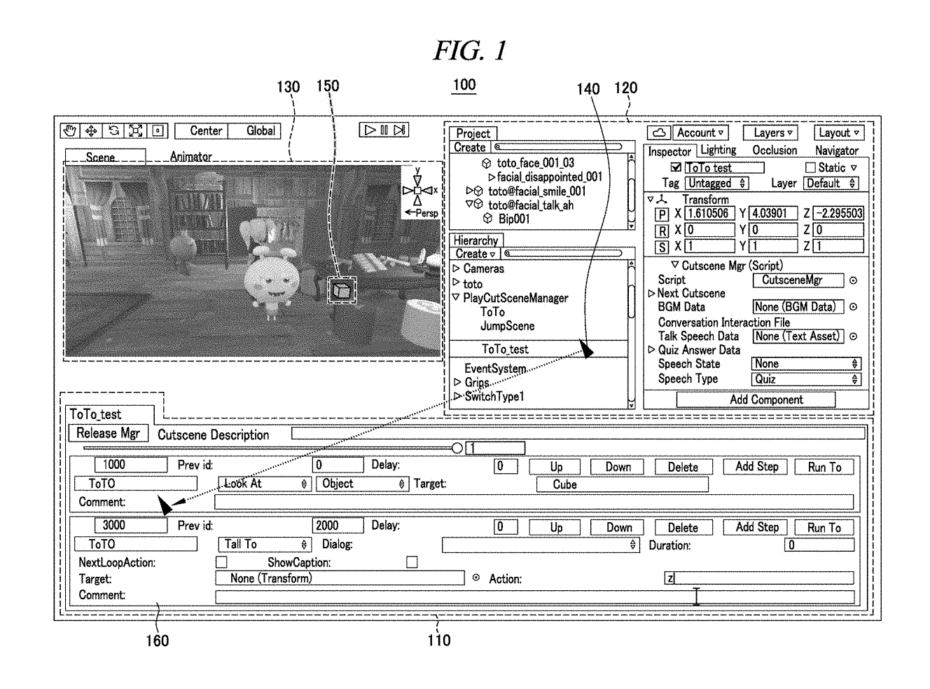

Hereinafter, a method and an apparatus for producing a virtual reality content in accordance with an exemplary embodiment will be described in detail with reference to FIG. 1 through FIG. 29.

FIG. 1 is a conceptual image provided to explain a method for producing a virtual reality content in accordance with an exemplary embodiment of the present disclosure.

Referring to FIG. 1, a virtual reality content producing apparatus 100 in accordance with an exemplary embodiment may display at least one action setting zone 110, 160 for setting actions of a character to be displayed in virtual reality, a list zone 120 for displaying setting values to be input into the at least one action setting zone 110, 160, and a preview zone 130 for displaying an action of a virtual reality content according to the setting values input into the action setting zone 110. Herein, the virtual reality content producing apparatus 100 may include the above-described device.

Further, the actions of the virtual reality character to be displayed may include a scene in which the virtual reality character performs an action alone or performs an action (hereinafter, referred to as “interactive action”) in response to a user input.

The list zone 120 may include a resource folder structure of the virtual reality content and objects constituting the virtual reality content. For example, the list zone 120 may include a character to be included in the virtual reality content and objects constituting a background.

Further, the list zone 120 may include an object for causing the virtual reality character to perform an action such as a shift of the virtual reality character's gaze (e.g., a cube 150 in FIG. 1). Furthermore, coordinates of an object, related scripts, and attribute values may be displayed.

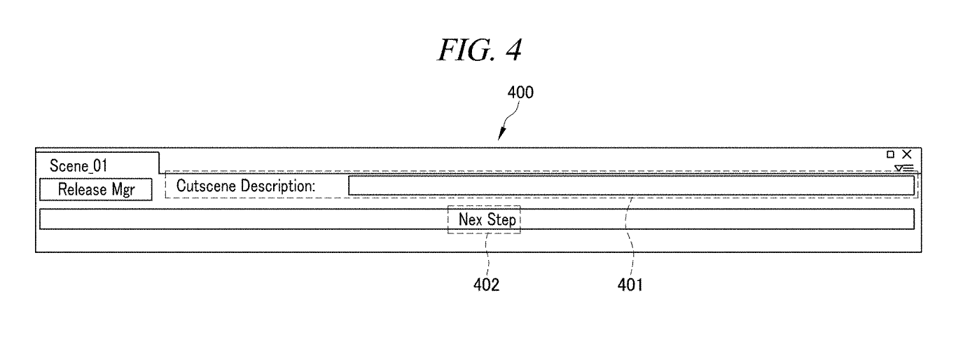

A predetermined setting value may be previously input into the at least one action setting zone 110, 160, and an action of the virtual reality character may be determined according to the previously input setting value. For example, a setting value for selecting the virtual reality character's gaze, facial expression, gesture, or voice may be previously input. Further, in the at least one action setting zone 110, 160, a user interface through which a setting value is input may be changed depending on a previously input kind of an action of the virtual reality character. The user interface in the action setting zone 110, 160 will be described later with reference to FIG. 4 through FIG. 28.

The virtual reality content producing apparatus 100 in accordance with an exemplary embodiment may receive a user input 140, and at least one of setting values displayed on the list zone 120 is shifted to the first action setting zone 110 and a setting value for a first action of the virtual reality character may be input.

Further, the virtual reality content producing apparatus 100 may receive a user input and input a setting value for a second action of the virtual reality character into the second action setting zone 160.

[symbol]

Herein, the virtual reality content producing apparatus 100 may display, on the preview zone 130, a screen for setting an action of the content according to the setting values of the first action setting zone 110 and the second action setting zone 160. For example, if the first action of the virtual reality character is a gaze shift and the second action is emotional expression, a setting value corresponding to an object as a target of the gaze shift is dragged and dropped to the first action setting zone 110 from the list zone 120 and set for the gaze shift in the first action setting zone 110 and a setting value corresponding to an selected emotion is set for the emotional expression of the character in the second action setting zone 160 on the basis of a user input. Then, a screen for setting actions of the content according to the setting values of the first action setting zone and the second action stetting zone may be displayed on the preview zone.

In this case, the character's actions (gaze shift and emotional expression) according to the preset setting values and the object 150 may be displayed on the preview zone 130, and a virtual reality content in which the virtual reality character shifts a gaze in response to a movement of the object may be produced. That is, if the virtual reality content producing apparatus 100 receives a user input to manipulate the object, the virtual reality content producing apparatus 100 may display, on the preview zone 130, a scene in which the virtual reality character performs a predetermined action according to the received user input.

For example, if the virtual reality content producing apparatus 100 produces a content about the virtual reality character's gaze shift, the virtual reality content producing apparatus 100 may display the object (e.g., cube 150) as a specified target of the gaze shift on the preview zone 130 and enable the virtual reality character to naturally look at the object. It is not necessarily limited to the cube, and setting values corresponding to various objects may be selected from the list zone 120 and then displayed. Then, the user may set a movable range of the virtual reality character's head by moving the specified target or intuitively set a movement speed of the head. Further, the user may increase or decrease the movement speed of the head. A virtual reality content may be produced on the basis of a value set by moving the specified target. Herein, the produced content may display an action of the virtual reality character or an action of interaction with the user.

In another example, if the virtual reality content producing apparatus 100 produces a content about an action for emotional expression of the virtual reality character, the virtual reality content producing apparatus 100 may display, on the preview zone 130, a facial expression and a gesture as emotional expression of the virtual reality character. The facial expression may roughly include joy, anger, sorrow, and pleasure, and the gesture may include various actions.

In yet another example, if the virtual reality content producing apparatus 100 produces a content about a voice of the virtual reality character, the virtual reality content producing apparatus 100 may enable a prepared voice to be output at a desired time. In this case, it is possible to set the virtual reality character's mouth to be moved at the same time when the voice is output.

Besides, various virtual reality contents such as a change of the character's costume or combinations of various actions may be produced.

Meanwhile, although FIG. 1 illustrates that there are two action setting zones, the present disclosure is not limited to this configuration. Since multiple action setting zones for action commands which may be overlapped to the virtual reality character are displayed, the user can easily set complicated actions of the character.

Meanwhile, actions of the first action setting zone and the second action setting zone may be set to be performed in different scenes. For example, if a scene of emotional expression of the character is set after a scene of gaze shift of the character, the two scenes may be linked in sequence and displayed on the preview zone 130.

Therefore, the user can intuitively produce the virtual reality content through the user interface including the action setting zone 110, the list zone 120, and the preview zone 130. Further, since multiple action setting zones corresponding to multiple scenes are provided, it is possible to produce a virtual reality content for a sequence formed by combining multiple scenes of actions of a virtual reality character according to setting values of the action setting zones on one screen. Furthermore, the method for producing a virtual reality content according to an exemplary embodiment enables a directing sequence to be user-intuitively displayed and also makes it easy for a user to move all objects in a content to a desired position at a desired time. Moreover, since a setting value is modified to modify an action to be output according to a user input value, it is possible to easily produce a virtual reality content moved in real time in response to the user's gaze (angle and direction of the user's face), voice, and a touch input through a hardware button of a VR apparatus.

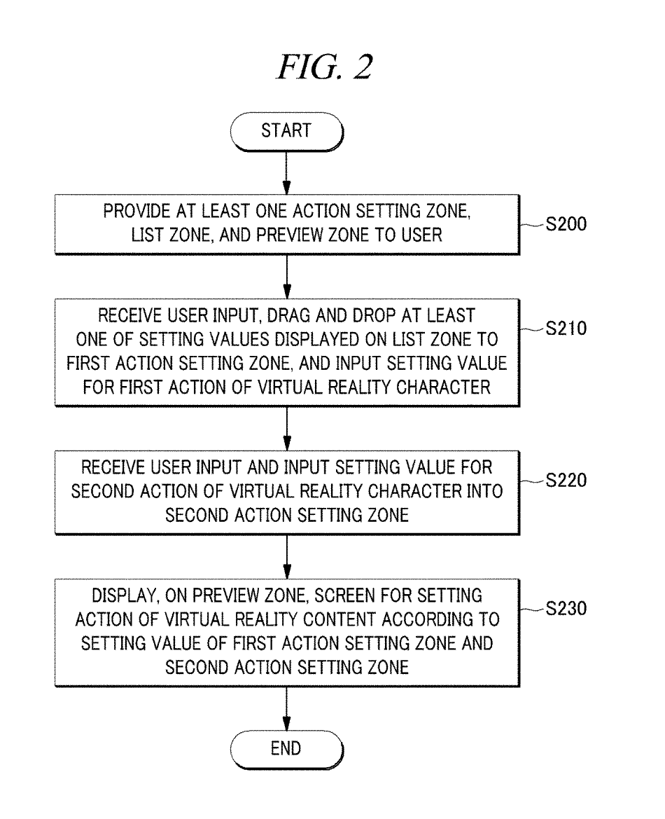

FIG. 2 is a flowchart illustrating the method for producing a virtual reality content in accordance with an exemplary embodiment of the present disclosure.

Referring to FIG. 2, in block S200, at least one action setting zone, a list zone, and a preview zone may be displayed according to the method for producing a virtual reality content. Herein, the action setting zone is provided for setting an action of a content to be displayed in virtual reality, the list zone is provided for displaying a setting value to be input into the action setting zone, and the preview zone is provided for displaying an action of a virtual reality content according to the setting value input into the action setting zone. Further, in the action setting zone, a user interface through which a setting value is input may be changed depending on a previously input kind of an action of a virtual reality character.

In block S210, a user input may be received, and at least one of setting values displayed on the list zone may be dragged and dropped to a first action setting zone and a setting value for a first action of the virtual reality character may be input according to the method for producing a virtual reality content.

In block S220, a user input may be received, and a setting value for a second action of the virtual reality character may be input into a second action setting zone according to the method for producing a virtual reality content.

In block S220, a screen showing actions of the virtual reality character according to setting values of the first action setting zone and the second action setting zone may be displayed on the preview zone. To be specific, the displaying on the preview zone may include displaying, on the preview zone, an action of the virtual reality character according to a setting value previously input into the first action setting zone and a setting value of the second action setting zone together with an object according to the setting value dragged and dropped to the first action setting zone. Further, a user input to manipulate the object may be received, and a scene in which the virtual reality character performs a predetermined action according to the received user input may be displayed on the preview zone. Accordingly, a virtual reality content in which an action of the character is played according to a predetermined time may be produced.

Further, the at least one action setting zone includes setting values for a sequence including multiple scenes. Therefore, it is possible to display, on the preview zone, a screen in which the respective scenes are continuously played according to the setting values of the action setting zone, and also possible to produce a virtual reality content on the basis of the screen displayed on the preview zone.

Furthermore, a movable range and an angle of the object may be modified to produce a virtual reality content in which the virtual reality character interacts in response to a user input and performs an action. In this case, the user input may include the user's gaze, voice, or physical input into the apparatus.

Moreover, if a first setting value for setting the virtual reality character's gaze shift is previously input into the action setting zone, the action setting zone displays an input zone for receiving a second setting value for setting the virtual reality character's gaze shift, and the second setting value may include a setting value about a movable range or movement speed of the virtual reality character's head.

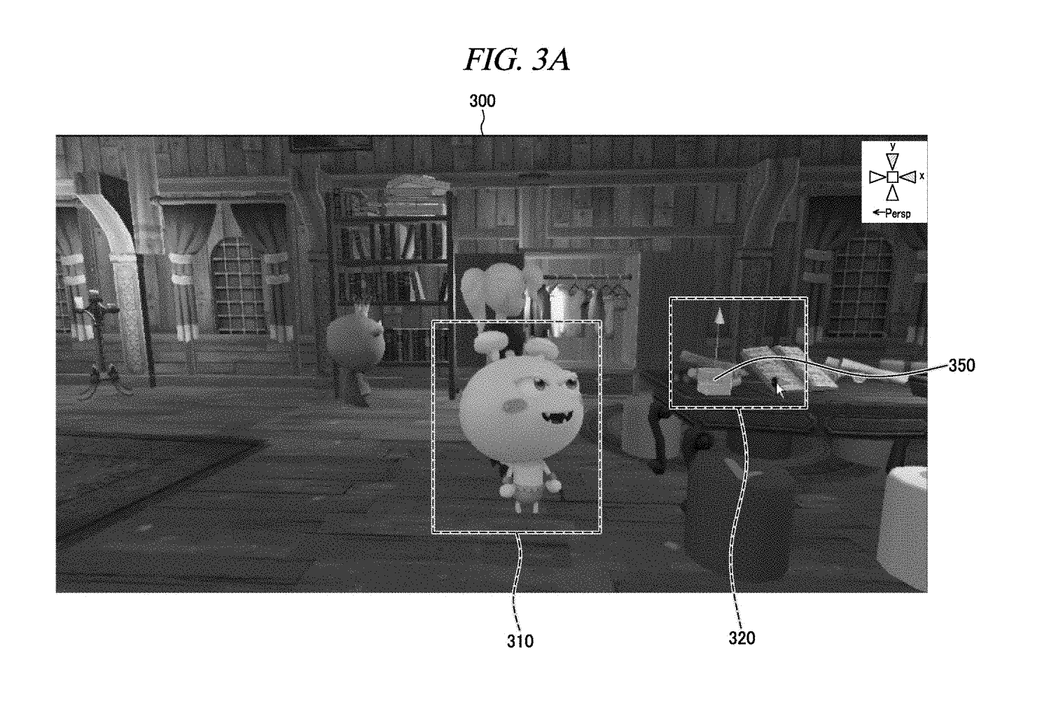

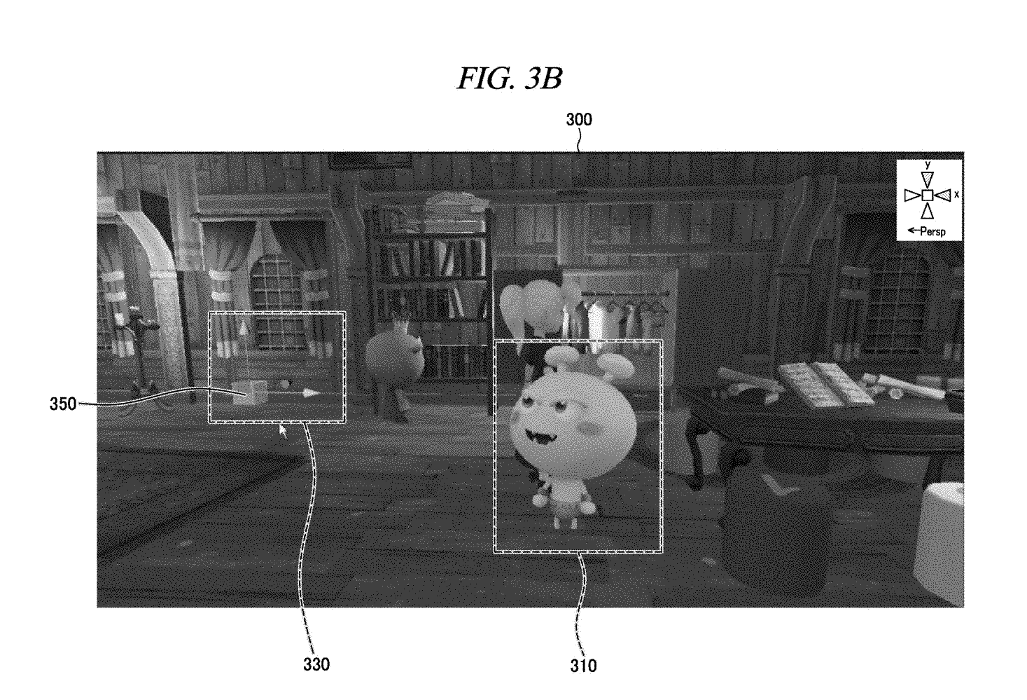

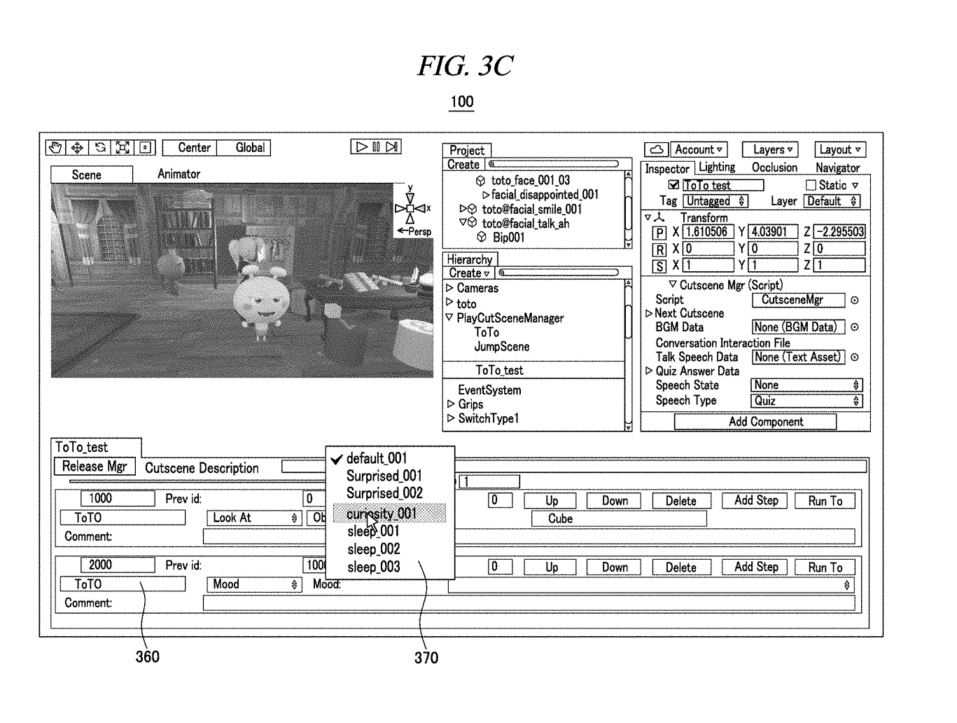

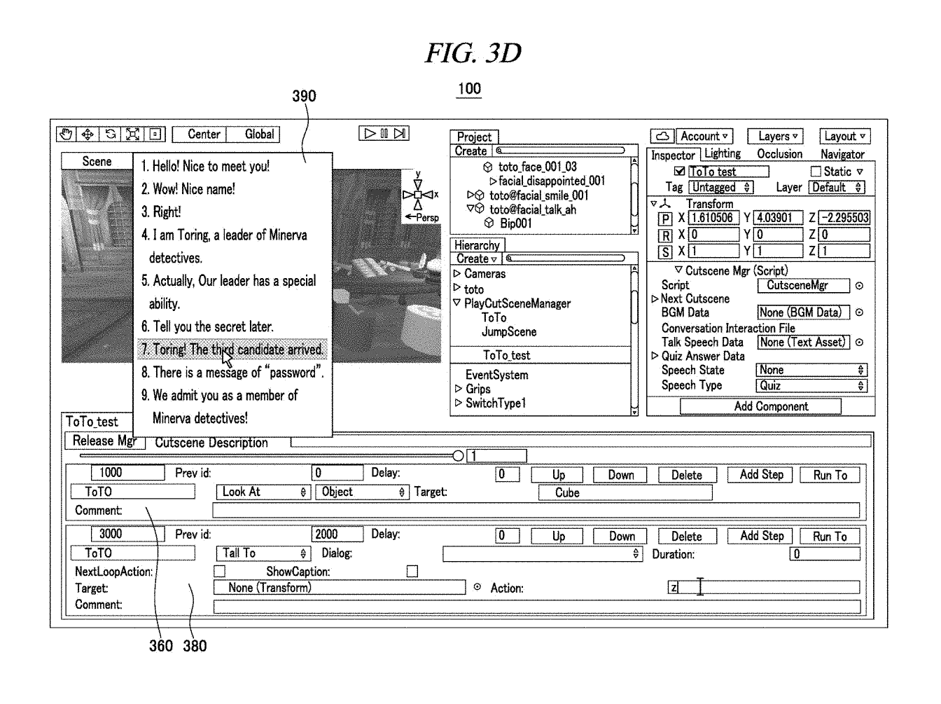

For example, FIG. 3A through FIG. 3D are images illustrating an example of the method for producing a virtual reality content in accordance with an exemplary embodiment of the present disclosure.

Referring to FIG. 3A and FIG. 3B, a virtual reality character 310 and an object 350 as a gaze shift target may be displayed on a first zone 320 of the preview zone 130. Therefore, if the object 350 is moved from the first zone 320 to a second zone 330 according to a user input, a gaze of the virtual reality character 310 may be shifted to look at the object 350. That is, a gaze of the virtual reality character 310 can be freely changed according to a movement of the object 350 and changes in gaze of the virtual reality character 310 for a predetermined time period may be output to produce a virtual reality content. Otherwise, a movable range and a speed of an interactive action may be determined by a movement of the object 350 from the first zone 320 to the second zone 330 according to a user input.

Meanwhile, referring to FIG. 3C, two action setting zones 360 may be displayed on the user interface. For example, the virtual reality character's gaze shift and emotional expression can be set at the same time. Therefore, an emotion selected in a setting zone 370 derived from the action setting zone 360 for emotional expression may be displayed together with a gaze shift on the preview zone.

Referring to FIG. 3D, three action setting zones 360 and 380 may be displayed on the user interface. For example, the virtual reality character's gaze shift, emotional expression, and voice output can be set at the same time. Therefore, a voice selected in a setting zone 390 for voice output may be set to be output together with predetermined gaze shift and emotional expression.

Further, a playback timeline can be set at the same time for the action setting zones. Thus, a duration of an action and the order of scenes can be determined.

That is, two or more action setting zones may be displayed on a screen and a user may input setting values into the multiple action setting zones, and, thus, all objects (characters and other structures in a background) in a content can be set to perform actions at a desired time in one user interface. The action setting zones are displayed as being arranged in parallel according to the order of being produced, and can be randomly changed in order by a user input (e.g., drag and drop).

Referring to FIG. 2 again, according to the method for producing a virtual reality content, if a first setting value for emotional expression of the virtual reality character is previously input into the at least one action setting zone, the action setting zone may display an input zone for receiving a second setting value for emotional expression of the virtual reality character, and the second setting value may include a setting value corresponding to a facial expression and a gesture of the virtual reality character.

Further, according to the method for producing a virtual reality content, if a first setting value for voice output of the virtual reality character is previously input into the at least one action setting zone, the action setting zone may display an input zone for receiving a second setting value for voice output of the virtual reality character, and the second setting value may include timing of voice output of the virtual reality character.

Hereinafter, an example of an action setting zone in the method for producing a virtual reality content in accordance with an exemplary embodiment of the present disclosure will be described with reference to FIG. 4 through FIG. 31.

FIG. 4 illustrates an initial user interface 400 for producing an action setting zone in the method for producing a virtual reality content.

Firstly, the initial user interface 400 displays a zone 401 in which a brief description of a scene Scene_01 constituting a virtual reality content currently selected by the user can be provided. Further, if the user selects a new step box 402, an initial sequence about the scene selected by the user is created. Herein, the scene may refer to a scene in which one or more actions are performed during a predetermined time period.

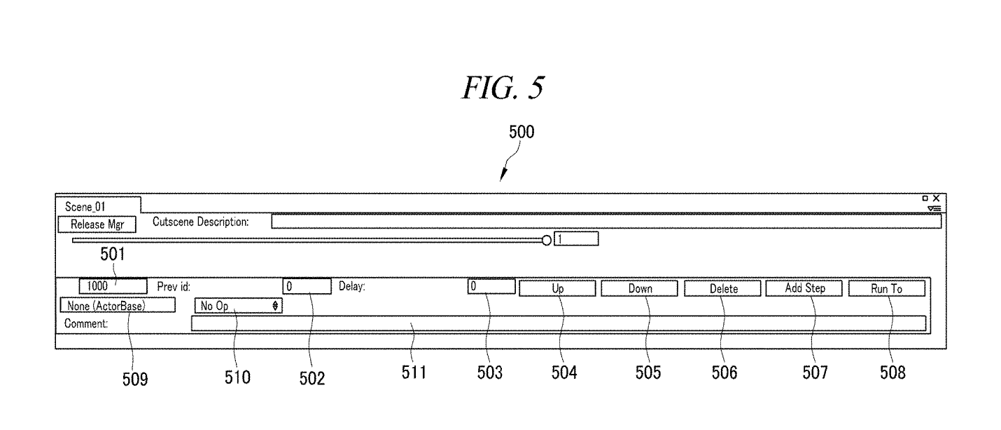

FIG. 5 illustrates an action setting zone 500 which is displayed after the initial sequence is created.

Referring to FIG. 5, a serial number of the sequence is displayed on a zone 501. The order of the sequence may be numerically organized and can also be changed randomly by changing serial numbers.

A sequence number of a previous step is input into a zone 502. Basically, if a sequence is created, a previous sequence number is automatically input.

In a zone 503, it is possible to set a time period of delay of a current sequence. The time unit is second, and after a delay for the set time period, the sequence is changed to a next sequence.

If a zone 504 is selected, the order of a corresponding sequence is moved up to a first previous step.

If a zone 505 is selected, the order of a corresponding sequence is moved down to a first next step.

If a zone 506 is selected, a corresponding sequence is dropped.

If a zone 507 is selected, a sequence subsequent to a corresponding sequence is created.

If a zone 508 is selected, an object or a character on a scene specified in a zone 509 is moved to coordinates at which a current sequence is located.

In the zone 509, an object (or character) as an action target during the current sequence is specified.

A comment about the current sequence may be written into a zone 511.

In an action zone 510, an action of the current sequence is specified. According to input of a setting value in the zone 510, an action of the virtual reality character included in the method for producing a virtual reality content in accordance with an exemplary embodiment may be set.

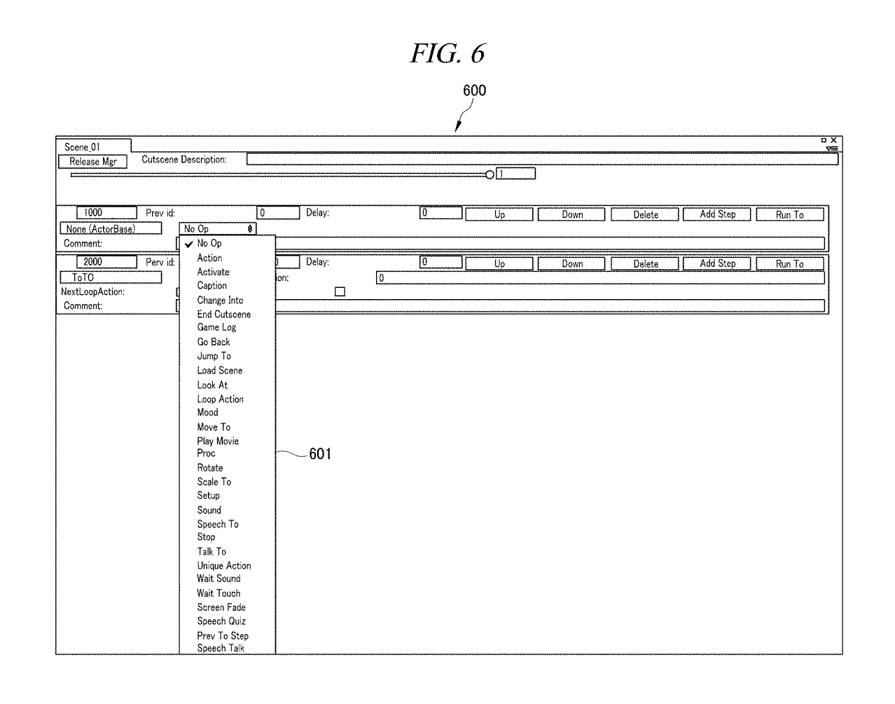

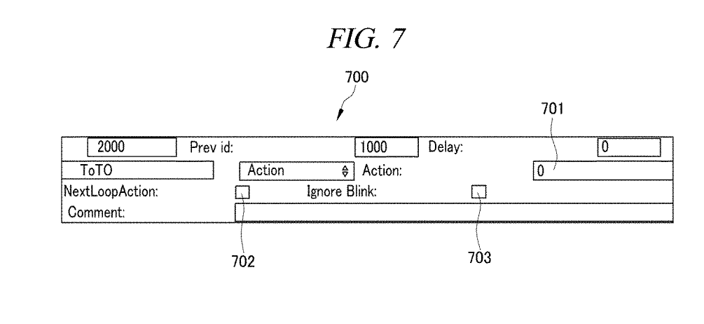

FIG. 6 illustrates an action command 601 which can be selected in the action zone 510. As illustrated in FIG. 6, the action command 601 includes various commands for various actions which can be performed by the virtual reality character. An exemplary embodiment in which an input zone for a selected value in an action selection zone 500 is changed depending on a selected command will be described with reference to FIG. 7 through FIG. 28.

For example, if “No Op” is selected, no action is performed. Further, if “Action” is selected, a predetermined specific action is performed.

For example, FIG. 7 illustrates an action setting zone 700 when an action command “Action” is selected.

Referring to FIG. 7, a number of an action may be input into a zone 701 to select the action from among predetermined actions, and if a predetermined action is repeated after the action is performed, a zone 702 may be ticked.

Meanwhile, if an option in a zone 703 is ticked, the virtual reality character does not show a blink animation. This option may be selected to avoid an awkward facial expression when the virtual reality character blinks while performing an action with a crying face.

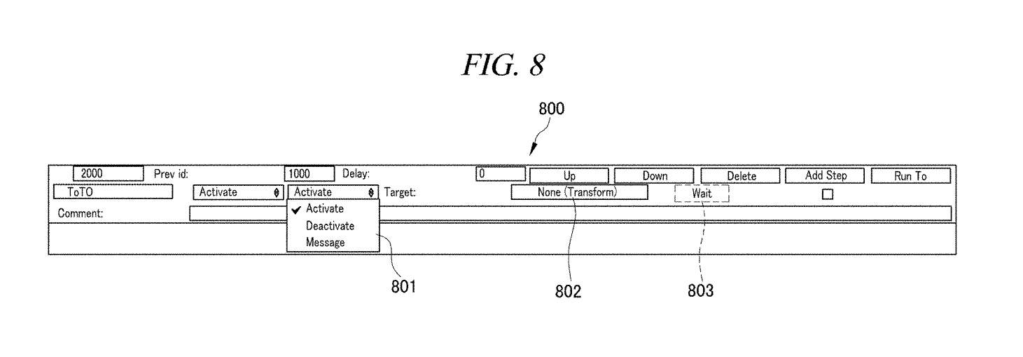

FIG. 8 illustrates an action setting zone 800 when an action command “Activate” is selected.

In an Activate selection zone 801, Activate is a command to present an object on a scene and Deactivate is a command to delete the object from the scene. Further, Message is a command to present a caption text.

A setting value in a zone 802 is configured to select an object to be presented or deleted from a list zone by drag and drop.

A setting value in a zone 803 is ticked if an object is wanted to be presented/deleted only when a specific input is received.

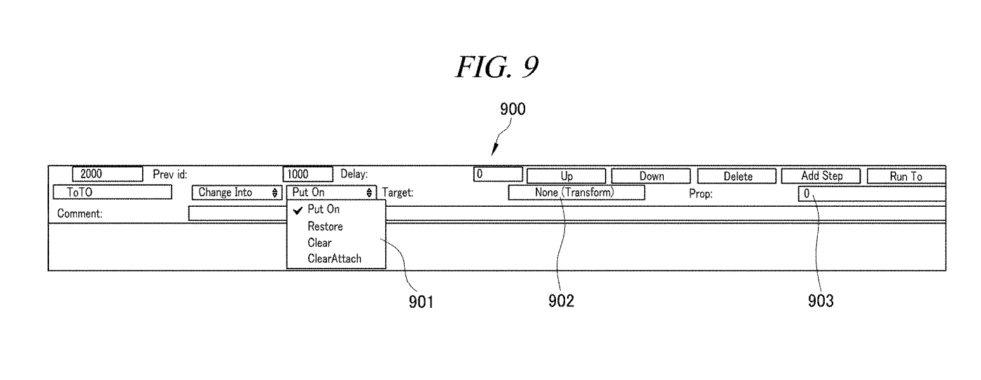

FIG. 9 illustrates an action setting zone 900 when an action command “Change into” is selected.

In a selection zone 901 for presenting/deleting the character's costume and belongings, Put on refers to a function to put a specified costume on the character, and Restore refers to a function to restore a costume deleted once. Further, Clear refers to a function to delete a currently worn costume/item.

A setting value in a zone 902 is configured to specify a costume to be changed for current one, and a setting value in a zone 903 is configured to specify an item to be carried by the virtual reality character.

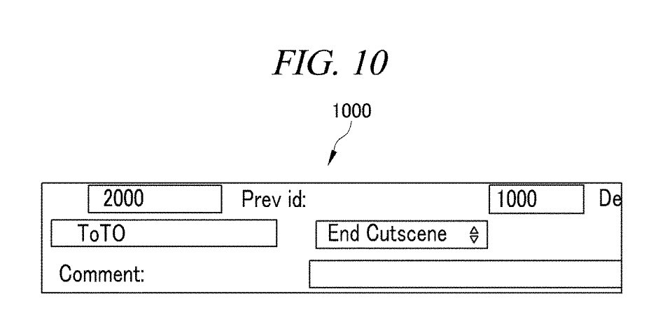

FIG. 10 illustrates an action setting zone 1000 when an action command “End Cutscene” is selected.

A setting value of End Cutscene may be input when a current scene is ended.

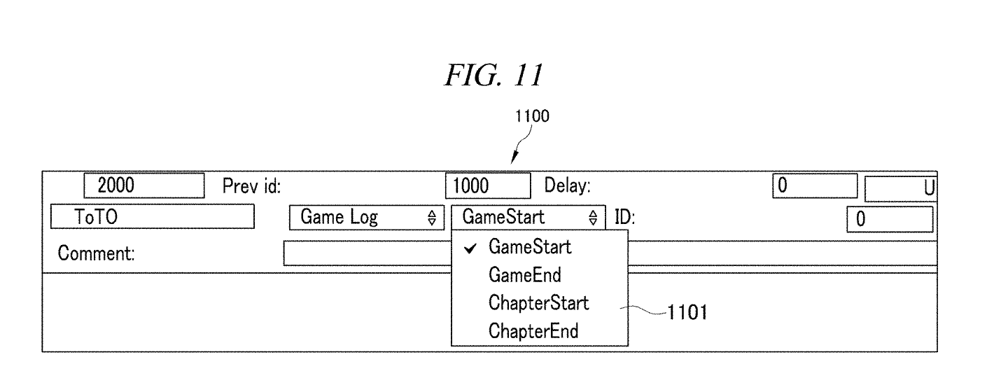

FIG. 11 illustrates an action setting zone 1100 when an action command “Game log” is selected.

The selection of the action command Game log makes it possible to leave log records in the middle of the content, and it is possible to select start/end of the content and start/end of a chapter from an additional selection zone 1101.

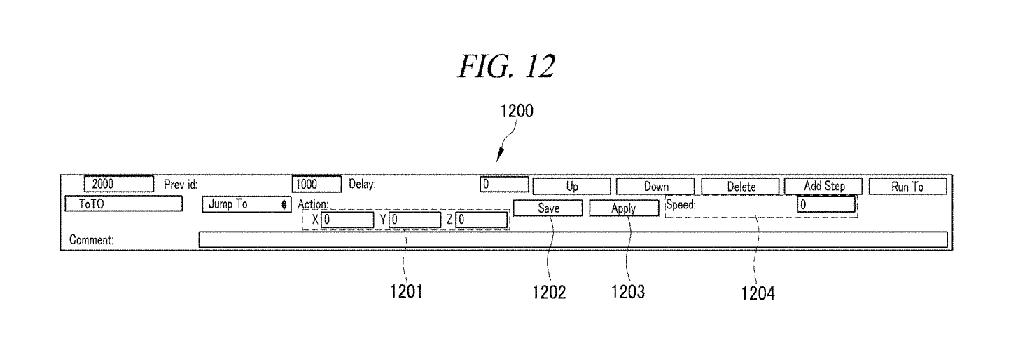

FIG. 12 illustrates an action setting zone 1200 when an action command “Jump to” related to a jump action of the character is selected.

As a setting value in a zone 1201, coordinate information about a position to which the character will jump is input.

If a button in a zone 1202 is selected, the currently input coordinate information is saved.

If a button in a zone 1203 is selected, coordinates selected from a scene editor are applied as the coordinates to which the character will jump.

A jumping speed may be specified by inputting a setting value into the zone 1203.

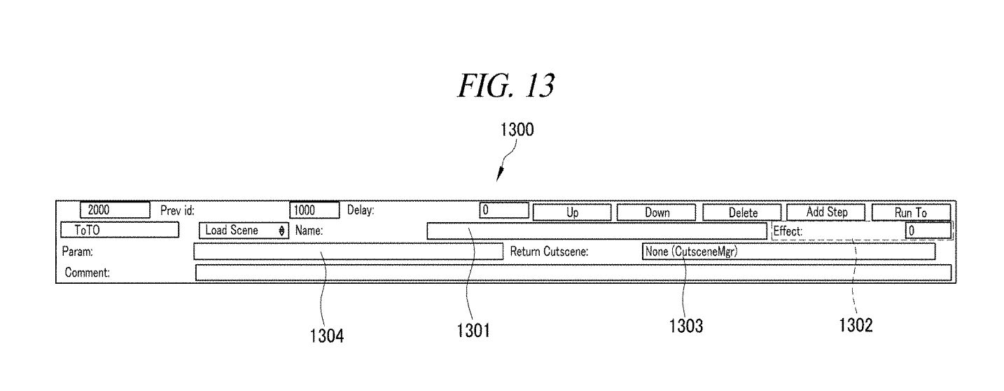

FIG. 13 illustrates an action setting zone 1300 when an action command “Load scene” to specify a scene to be presented after a current scene is selected.

As a setting value in a zone 1301, a name of a scene to be presented is input.

As a setting value in a zone 1302, an effect of a change to the scene to be presented may be selected.

A setting value in a zone 1303 is configured to specify a scene subsequent to the scene to be presented.

A setting value in a zone 1304 may be input if there is a parameter to be transferred when the scene is changed.

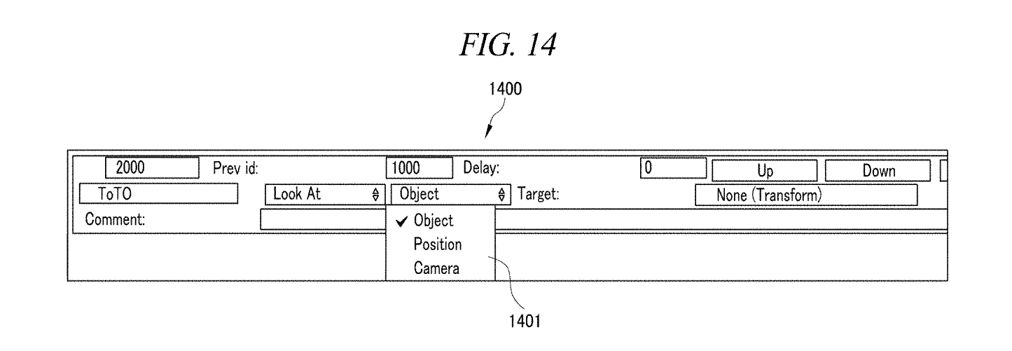

FIG. 14 illustrates an action setting zone 1400 when an action command “Look at” related to a gaze shift is selected.

Three options including an option of looking at an object, an option of looking at a specific position, and an option of looking at a camera on the scene may be set from a selection menu 1401. Herein, the object may be selected from the list zone.

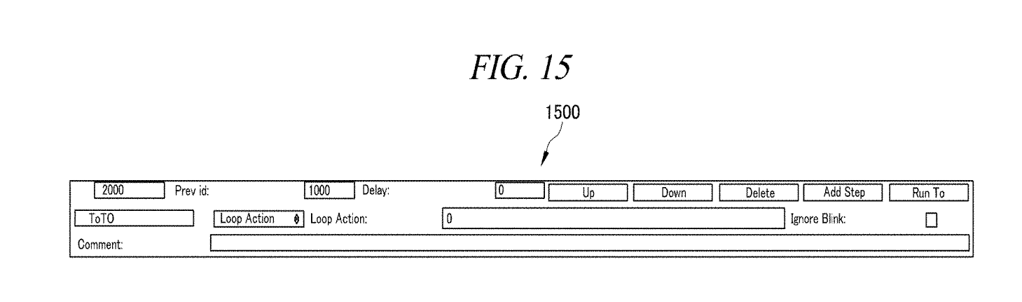

FIG. 15 illustrates an action setting zone 1500 when an action command “Loop action” to set the character to repeatedly perform an action is selected.

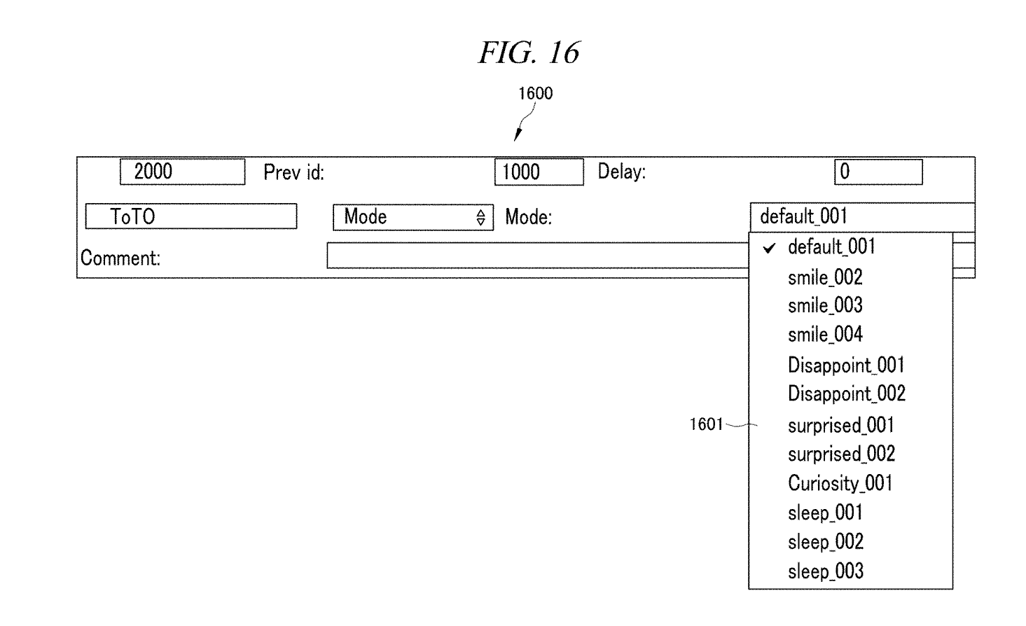

FIG. 16 illustrates an action setting zone 1600 when an action command “Mood” is selected.

In a Mood zone, a function related to emotional expression of the virtual reality character may be set. A facial expression of the character may be selected from a selection menu 1601.

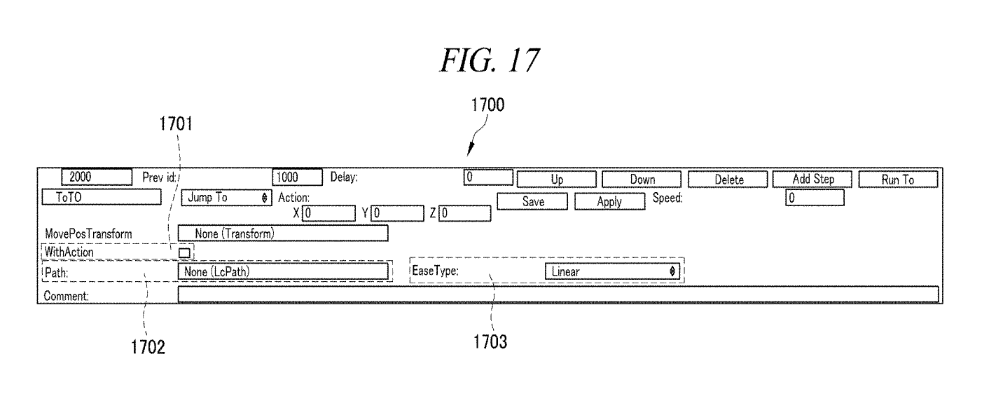

FIG. 17 illustrates an action setting zone 1700 when an action command “Move to” is selected.

Herein, Move to refers to a function used when the character or the object is moved.

A zone 1701 is ticked when a specific action needs to be performed on move.

As a setting value in a zone 1702, details of a path for a movement to a specific position may be specified.

As a setting value in a zone 1703, details of a speed for a movement to the specific position may be specified.

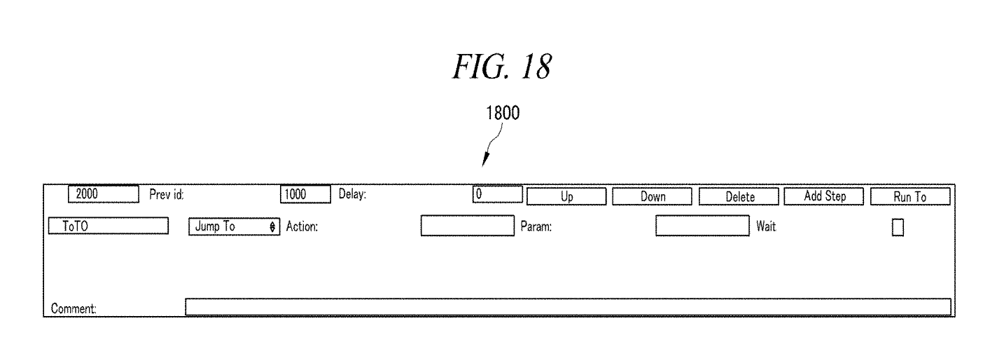

FIG. 18 illustrates an action setting zone 1800 when an action command “Proc” is selected.

According to the action command Proc, it is possible to specify a reaction when the character is touched by a hand in a wait state. For example, an automatic reaction to a current time/weather (e.g., output of a speech such as “Oh! It's raining now.” and a movement upon checking weather information) is included.

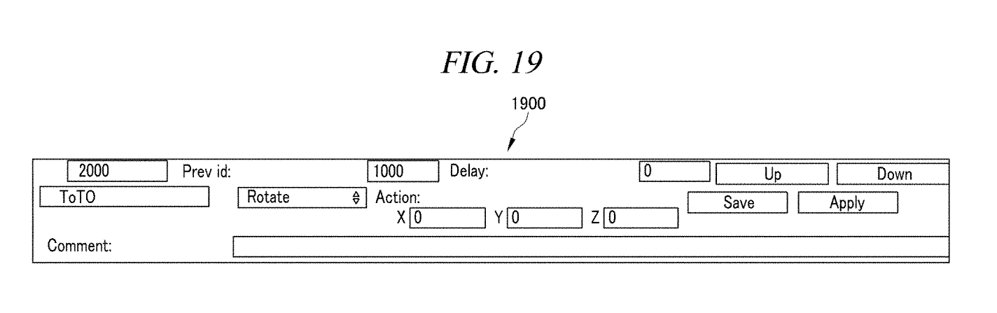

FIG. 19 illustrates an action setting zone 1900 when an action command “Rotate” is selected.

The action command Rotate may be selected to specify a direction (of a whole body rather than a gaze) of the character.

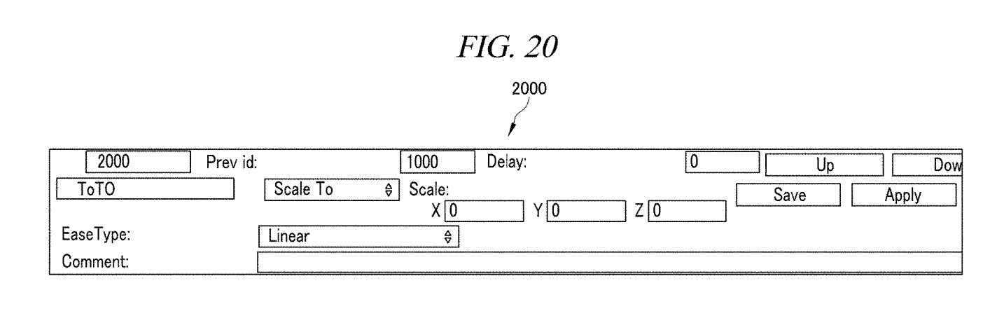

FIG. 20 illustrates an action setting zone 2000 when an action command “Scale to” is selected.

The action command Scale to may be selected to change a size of a character/object.

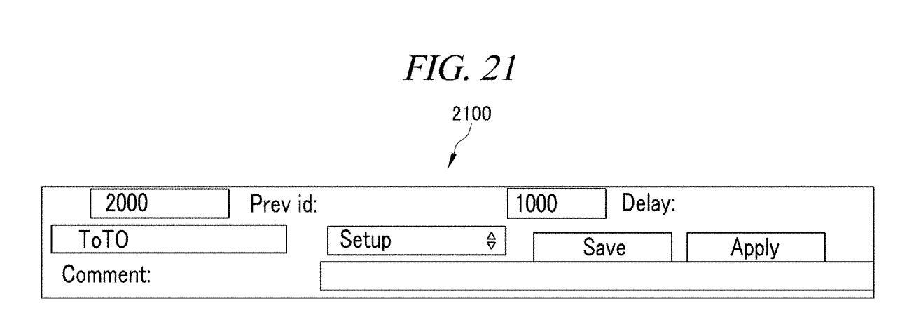

FIG. 21 illustrates an action setting zone 2100 when an action command “Setup” is selected.

The action command Setup may be selected to set up a character on a scene when an initial scene is produced.

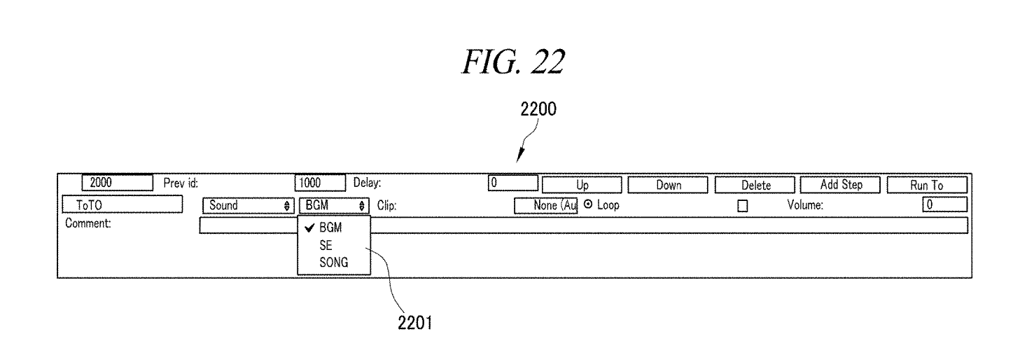

FIG. 22 illustrates an action setting zone 2200 when an action command “Sound” is selected.

The action command Sound may be selected to specify a background music, sound effects, and a song on a current scene and adjust a volume.

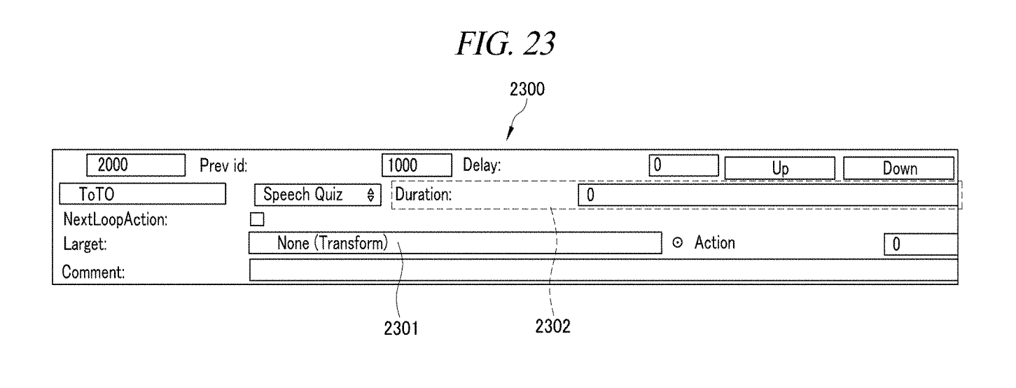

FIG. 23 illustrates an action setting zone 2300 when an action command “Speech to” is selected.

The action command Speech to may be selected to set a character to speak to a specified target. Speech to is different from Talk to in that all characters on a scene can be set to look at a specified target.

As a setting value in a zone 2301, a target to look at during speech is specified.

As a setting value in a zone 2302, a value for setting a time period for speech may be input.

Meanwhile, an action command “Stop” may be selected to stop all actions of characters applied on a current scene.

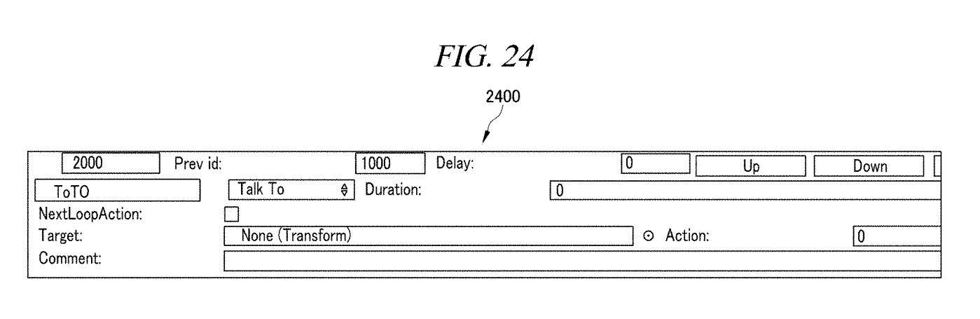

FIG. 24 illustrates an action setting zone 2400 when an action command “Talk to” is selected. The action command Talk to refers to a function to set a character to look at and talk to a specified target.

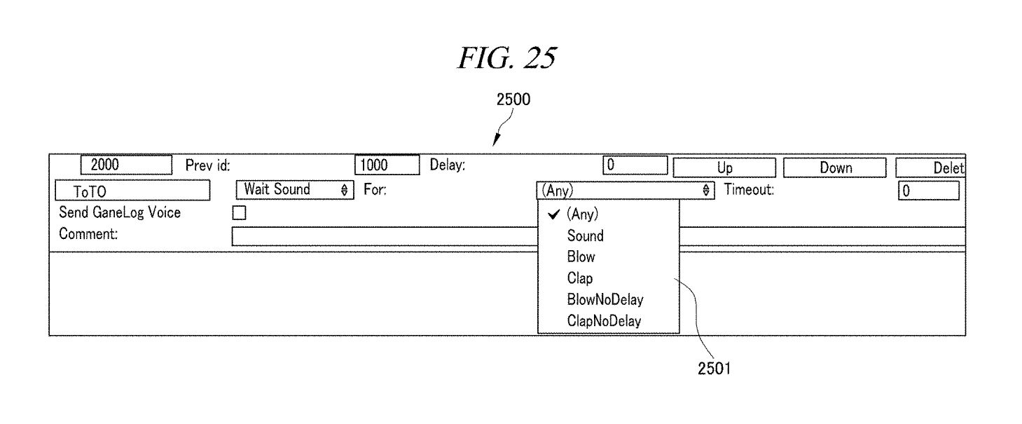

FIG. 25 illustrates an action setting zone 2500 when an action command “Wait sound” is selected.

The action command Wait sound may be selected to set a function of receiving a sound, and may be used to set a user interactive action.

In a selection zone 2501, a sound, a sound of blowing, and a clap can be set to be distinguished from each other. Further, a time period of delay in receiving a sound can be set.

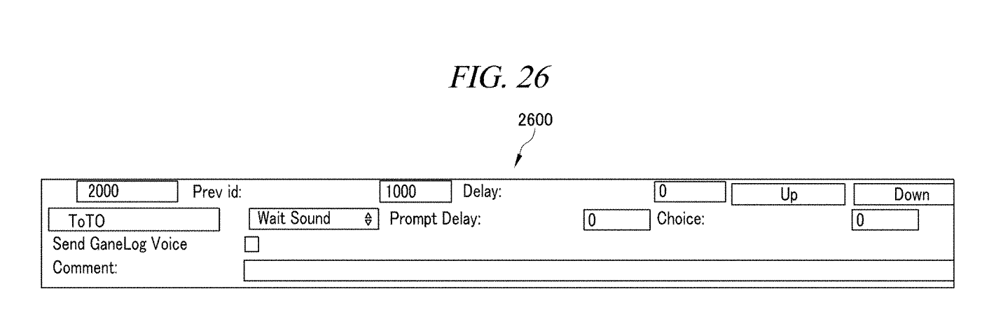

FIG. 26 illustrates an action setting zone 2600 when an action command “Wait touch” is selected.

The action command Wait touch refers to a function to receive a user's input (touch), and may be used to set a user interactive action.

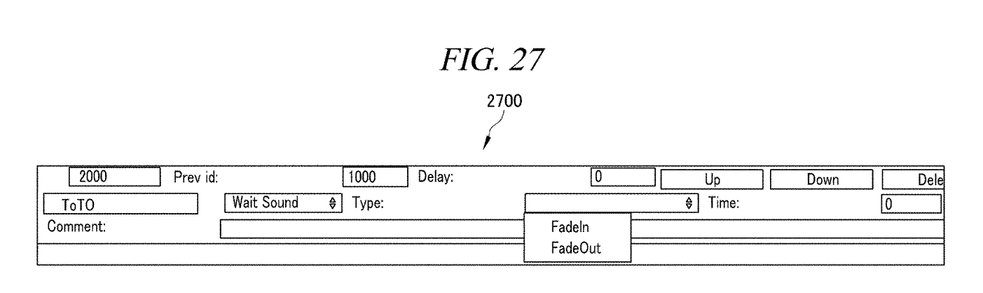

FIG. 27 illustrates an action setting zone 2700 when an action command “Screen fade” is selected.

The action command Screen fade refers to a function to fade a scene in/out.

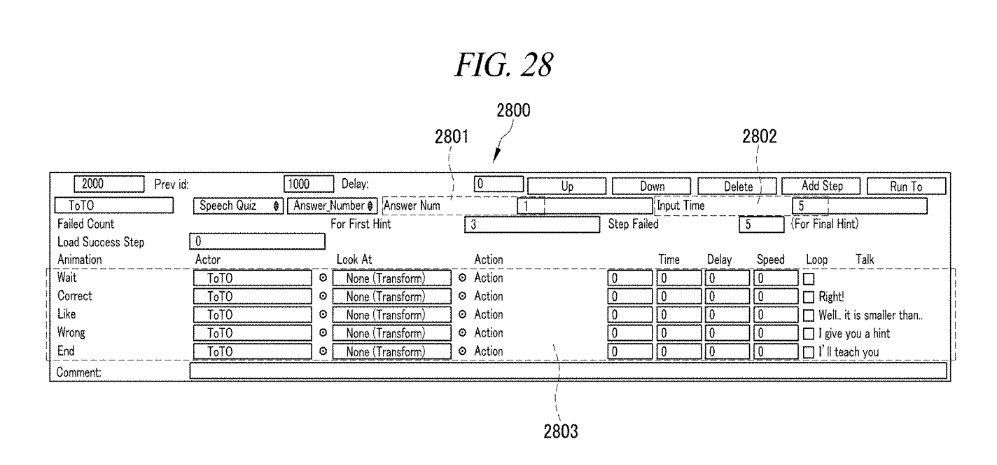

FIG. 28 illustrates an action setting zone 2800 when an action command “Speech quiz” is selected

The action command Speech quiz refers to a function to set Al related to a question and an answer during a conversation with a virtual reality character.

As a setting value in a zone 2801, the number of correct answers is set.

As a setting value in a zone 2802, a waiting time for an answer is set.

As shown in a zone 2803, the kind of an input answer and a reaction (action and output voice) to the answer may be set. Herein, the number of the kinds of answers and reactions may be increased as the user wants.

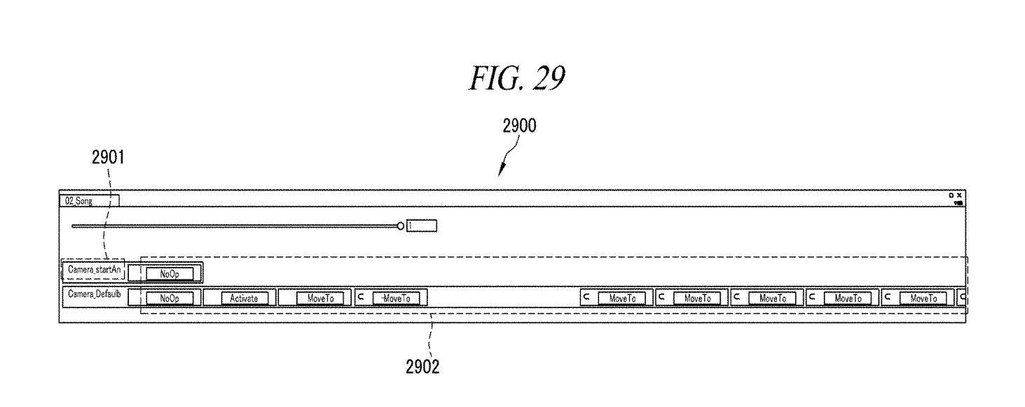

FIG. 29 illustrates a timeline viewer zone 2900 in accordance with an exemplary embodiment.

The timeline viewer zone 2900 is displayed on one side of the user interface for the method for producing a virtual reality content and makes it possible to see the whole scene of actions of the virtual reality content set in the action setting zones described above with reference to FIG. 4 through FIG. 28 in the form of timeline.

Firstly, a zone 2901 displays a name of an object/character set for a current scene. The number of vertical items may be increased to be equal to the number of objects/characters on the scene. Therefore, all objects in a virtual reality content may be set to be displayed or perform actions at a desired time.

Further, a zone 2902 displays an action sequence of a corresponding object/character. A capital letter preceding an action command may show which object/character is related to a corresponding action.

Meanwhile, as an example of an action of the virtual reality character, a virtual reality content in which the user and the character realistically interact with each other may be produced.

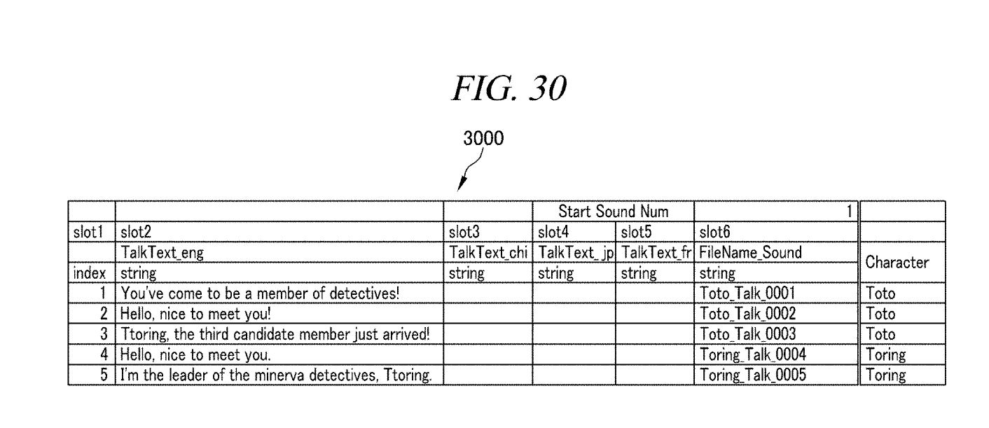

FIG. 30 is an image provided to explain a process for implementing voice output and lip-synching in accordance with an exemplary embodiment.

Referring to FIG. 30, for example, if Korean and English captions are input into an Excel file 3000, a name of an audio file is automatically set. Then, a character to say these captions is specified in the last column.

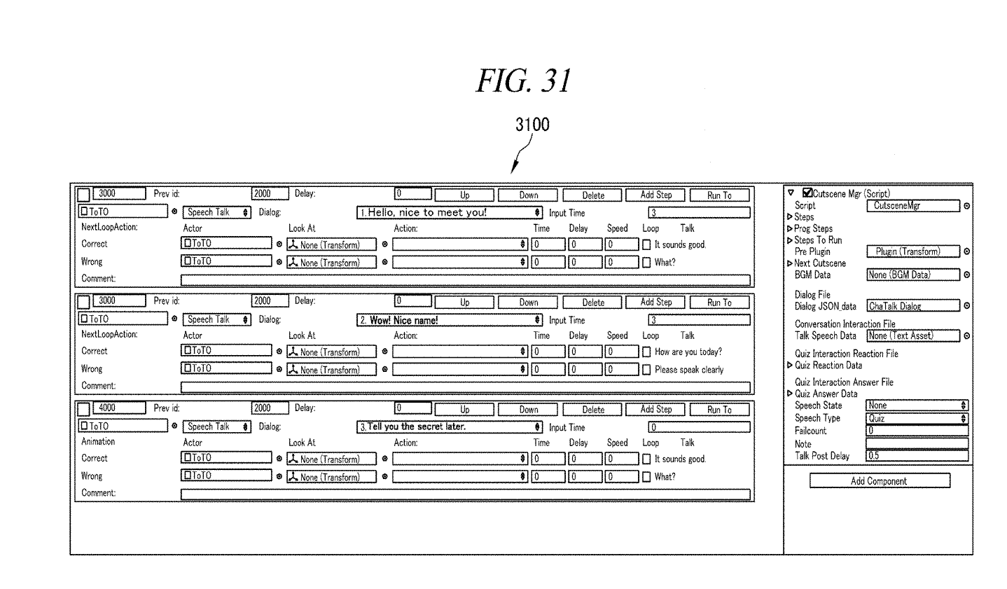

The generated Excel file 3000 is converted (exported) by a macro function to a file of a predetermined format (e.g., json file) to be applicable to the method for producing a virtual reality content according to an exemplary embodiment. Then, if the converted file and an audio file corresponding thereto are imported on the user interface, values stored in the Excel file 3000 may be automatically described in an action setting zone 3100 illustrated in FIG. 31.

Referring to FIG. 31, it can be seen that captions input into the action setting zones are set in a left zone (texts of the converted file are recognized). Further, it can be seen that the Jason file imported from a file manager is registered in a right zone. A text of the converted file of FIG. 30 is output as a caption when a content is played on the preview zone and a voice in the audio file is also output.

In particular, according to the method for producing a virtual reality content according to an exemplary embodiment, it is possible to direct a specified character to lip sync by automatically outputting mouth shapes respectively corresponding to waveforms of recorded audio. That is, mouth shape data corresponding to “Ah” and “Oh” may be prepared and waveforms of recorded audio may be analyzed, and then a mouth shape for “Ah” and a mouth shape for “Oh” may be mixed to express mouth shapes to be matched with pronunciation. That is, a text of a recorded audio file may be analyzed and shapes of consonants and vowels included in the text may be extracted, and then mouth shapes respectively corresponding to the consonants/vowels may be expressed. A period of time in which the character opens his/her mouth and says the text may be automatically set by detecting a playback time of the audio file.

Therefore, it is possible to easily produce a scene in which a user and a virtual reality character realistically interact with each other.

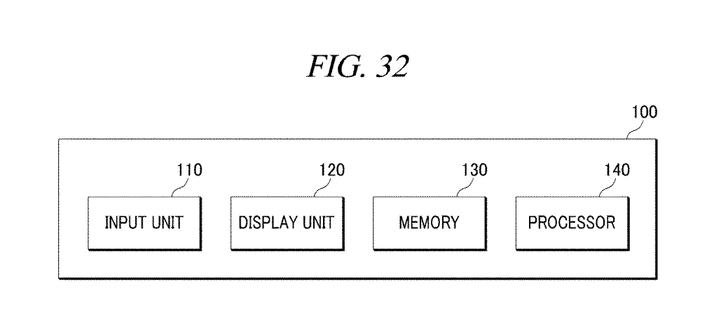

FIG. 32 is a block diagram illustrating an apparatus for producing a virtual reality content in accordance with an exemplary embodiment of the present disclosure. The virtual reality content producing apparatus 100 in accordance with an exemplary embodiment may include an input unit 110, a display unit 120, a memory 130, and a processor 140.

Meanwhile, FIG. 32 only illustrates the components related to the present exemplary embodiment. Such illustration is provided only for convenience in explanation, but the present disclosure is not limited thereto. Therefore, it would be understood by those skilled in the art that other generally-used components may be further included in addition to the components illustrated in FIG. 32.

Further, it would be easily understood by those skilled in the art that even if the details described above with reference to FIG. 1 through FIG. 31 are omitted from the following description, they can be implemented by the virtual reality content producing apparatus 100 illustrated in FIG. 32.

The input unit 110 includes various input devices, such as a touch panel, a key button, etc., that enable a user to input information, and is configured to receive a user input and input a setting value into an action setting zone or input a setting value included in a list zone into the action setting zone by drag and drop.

A method for producing a virtual reality content may be displayed on the display unit 120. In the display unit 120, a touch pad having a layer structure with a display panel may be referred to as a touch screen. Meanwhile, if the user input unit 110 is configured as a touch screen, the user input unit 110 may perform a function of the display unit 120.

A program for performing the method for producing a virtual reality content may be stored in the memory 130. The memory 130 may include at least one type of storage medium including a flash memory, a hard disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk.

The processor 140 may execute the above-described program. When the program stored in the memory 130 is executed, the processor 140 displays, on the display unit 120, an action setting zone for setting an action of a content to be displayed in virtual reality, a list zone for displaying a setting value to be input into the action setting zone, and a preview zone. If a user input is received through the input unit 110 and at least one of setting values displayed on the list zone is dragged and dropped to the action setting zone, the processor 140 may control a screen for setting an action of a content according to the setting value dragged and dropped to the action setting zone to be displayed on the preview zone.

Further, the process 140 may control the virtual reality content producing apparatus 100 to display at least one action setting zone for setting an action of a virtual reality character to be displayed in virtual reality, a list zone for displaying a setting value to be input into the action setting zone, and a preview zone for displaying an action of a virtual reality character according to the setting value input into the action setting zone; receive a user input, drag and drop at least one of setting values displayed on the list zone to a first action setting zone, and input a setting value for a first action of the virtual reality character; receive a user input and input a setting value for a second action of the virtual reality character into a second action setting zone; and display, on the preview zone, a screen for setting actions of the virtual reality character according to setting values of the first action setting zone and the second action setting zone.

The embodiment of the present disclosure can be embodied in a storage medium including instruction codes executable by a computer such as a program module executed by the computer. Besides, the data structure in accordance with the embodiment of the present disclosure can be stored in the storage medium executable by the computer. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The system and method of the present disclosure has been explained in relation to a specific embodiment, but its components or a part or all of its operations can be embodied by using a computer system having general-purpose hardware architecture.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A method for producing a virtual reality content for at least one sequence performed by a virtual reality content producing apparatus, the method comprising:
displaying at least one action setting zone for setting an action of a virtual reality character to be displayed in virtual reality, a list zone for displaying a setting value to be input into the at least one action setting zone, and a preview zone for displaying an action of the virtual reality character according to the setting value input into the action setting zone;
receiving a user input, dragging and dropping at least one of setting values, which is a setting value for a first action of the virtual reality character, displayed on the list zone to a first action setting zone;
receiving a user input and setting a setting value for a second action of the virtual reality character into a second action setting zone; and
displaying, on the preview zone, at least one scene showing actions of the virtual reality character according to setting values of the first action setting zone and the second action setting zone,
wherein the first and second action setting zones are displayed as being arranged in parallel according to the order of being produced and are able to be randomly changed in order by a user input.

2. The method of claim 1,
wherein the at least one action setting zone includes setting values for a sequence including multiple scenes, and
the displaying on the preview zone includes:
continuously playing, on the preview zone, the multiple scenes according to the setting values.

3. The method of claim 2, further comprising:
producing a virtual reality content in which an action of the virtual reality character is played according to a predetermined time.

4. The method of claim 1,
wherein the displaying on the preview zone includes:
displaying, on the preview zone, actions of the virtual reality character according to setting values of the first action setting zone and the second action setting zone together with an object according to the setting value dragged and dropped to the first action setting zone; and
receiving a user input to manipulate the object and displaying, on the preview zone, a scene in which the virtual reality character performs a predetermined action according to the received user input.

5. The method of claim 4, further comprising:
producing a virtual reality content in which the virtual reality character interacts in response to a user input and performs an action by modifying a movable range and an angle of the object.

6. The method of claim 4,
wherein the user input includes the user's gaze, voice, or physical input into the apparatus.

7. The method of claim 1,
wherein in the at least one action setting zone, a user interface through which a setting value is input is changed depending on a previously input kind of an action of a virtual reality character.

8. The method of claim 1,
wherein if a first setting value for setting a virtual reality character's gaze shift is previously input into the at least one action setting zone,
the action setting zone displays an input zone for receiving a second setting value for setting the virtual reality character's gaze shift, and
the second setting value includes a setting value about a movable range or movement speed of the virtual reality character's head.

9. The method of claim 1,
wherein if a first setting value for emotional expression of a virtual reality character is previously input into the at least one action setting zone,
the action setting zone displays an input zone for receiving a second setting value for emotional expression of the virtual reality character, and
the second setting value includes a setting value corresponding to a facial expression and a gesture of the virtual reality character.

10. The method of claim 1,
wherein if a first setting value for voice output of a virtual reality character is previously input into the at least one action setting zone,
the action setting zone displays an input zone for receiving a second setting value for voice output of the virtual reality character, and
the second setting value includes timing of voice output of the virtual reality character.

11. An apparatus for producing a virtual reality content for at least one sequence comprising:
a memory in which a program for performing a method for producing a virtual reality content is stored;
a display unit configured to display the method for producing a virtual reality content; and
a processor configured to execute the program,
wherein when the program is executed, the processor displays, on the display unit, at least one action setting zone for setting an action of a virtual reality character to be displayed in virtual reality, a list zone for displaying a setting value to be input into the action setting zone, and a preview zone for displaying an action of a virtual reality character according to the setting value input into the action setting zone,
the processor controls the apparatus to receive a user input and drag and drop at least one of setting values, which is a setting value for a first action of the virtual reality character, displayed on the list zone to a first action setting zone;
receive a user input and set a setting value for a second action of the virtual reality character into a second action setting zone; and
display, on the preview zone, at least one scene showing actions of the virtual reality character according to setting values of the first action setting zone and the second action setting zone,
wherein the first and second action setting zones are displayed as being arranged in parallel according to the order of being produced and are able to be randomly changed in order by a user input.

12. A computer program stored in a storage medium for executing a method for implementing a method for producing a virtual reality content for at least one sequence of claim 1.
